(19) United States
(12) Patent Application Publication
(10) Pub. No.: US 2011/0001401 A1
(43) Pub. Date: Jan. 6, 2011

(54) Welding Assembled Structure of Diode in Rectifier for Generator

(75) Inventors: Ping-Fung Tsai, Taipei (TW); Fu-Sheng Liang, Taipei (TW)

Correspondence Address: CLIFFORD B. PERRY, 270 N. El Camino Real, No. F-347, ENCINITAS, CA, 92024, US

(73) Assignee: Victory Industrial Corporation, Taipei (TW)

(21) Appl. No.: 12/825,222

(22) Filed: Jun. 28, 2010

(30) Foreign Application Priority Data
Jul. 3, 2009 (TW) 098212147

(51) Int. Cl. H02K 11/04

(52) U.S. Cl. 310/68 D

(57) ABSTRACT

A welding assembled structure of a diode in a rectifier is disclosed. Therein, a solid joint lead which is a lengthwise member with one end contacting a leader frame of the rectifier, and an opposite extended end bent and extended outward the leader frame, while having a soldering tag located at one side of the extended end. The diode has a pin with an extended end located in a restricting area defined by the solid joint lead and the soldering tag. The soldering tag is welded by a spot welding process and bent toward the solid joint lead under stress when melted at a high temperature and, so as to deform and clamp the pin of the diode together with the solid joint lead, thereby fix-clamping the pin of the diode. The diode is secured by spot welding from loosening during operation, thereby ensuring the performance of the rectifier.

### BACKGROUND

1. Technical Field

The present invention is related to fixing structures of diode in generator rectifiers, and more particularly, to a welding assembled structure of a diode in a rectifier for a generator.

2. Description of Related Art

It is a known art using an AC generator to serve as generating mechanism in a car system. Further, the generator is typically equipped with a rectifier to provide rectification function.

However, the existing rectifiers are designed such that the conjunctive configuration between rectifiers and diode directly affects, among others, the conductivity, stability, and operational performance of the diode. Given the conventional less-than-perfect corresponding design between a leader frame of a rectifier and pin of a diode, either spot welding or ion welding could only achieve limited effects. Among known technologies, burning by means of plasma machine to connect diode could achieve good effects; however, both immense costs and labor turn out to be the disadvantages of overall manufacturing costs.

### SUMMARY

To overcome disadvantages revealed in existing technologies, the purpose of the present invention is to provide a welding assembled structure of a diode in a rectifier for a generator for solving issues encountered with existing technologies.

To achieve the purpose presented, the present invention provides a welding assembled structure of a diode in a rectifier of a generator, characterized in:

a solid joint lead which is a lengthwise member made of a metal-based conductive material and fixed on a leader frame of the rectifier, with one end contacting a fringe of the leader frame, and an opposite extended end bent and extended outward the leader frame while having a soldering tag located at one side of the extended end, wherein the soldering tag has a width narrowed at a connecting portion to which the solid joint lead is connected so that a U-shaped restricting area is defined between the soldering tag and the solid joint lead before the soldering tag is later welded; and

the diode comprising a fixed mount and a pin, wherein the fixed mount is a columnar member with a toothed periphery, and the pin is coupled with the fixed mount and extends towards the solid joint lead, an extended end of the pin corresponding to the restricting area defined by the solid joint lead and the soldering tag; wherein the soldering tag is welded by a spot welding process and is pressed toward the solid joint lead when melted at a high temperature, so that the soldering tag deforms and clamps the pin of the diode together with the solid joint lead. By the above structure, the cooled solid joint lead can fix the pin of the diode firmly.

The advantage of the present invention is that the diode is secured in between the solid joint lead and the soldering tag by spot welding from loosening during operation, thereby ensuring the performance of the rectifier. In addition, the narrowed connecting portion of the soldering tag leads to a relatively large resistance thereon when a current flow passes therethrough during spot welding, so as to produce instantaneous high heat that facilitates welding, thereby achieving convenient fabrication. By using spot welding, not only can the process be efficient and fast, but also the manufacture costs can be significantly reduced.

### BRIEF DESCRIPTION OF THE DRAWINGS

FIG. 1 is a schematic drawing showing the subject matter of present invention applied in practice.

FIG. 2 is a partial schematic drawing showing the subject matter of present invention applied in practice.

FIG. 3 is a perspective view of the subject matter of the present invention.

FIG. 4 is a schematic drawing illustrating a spot welding process according to the present invention.

FIG. 5 is a perspective view of the subject matter of the present invention after spot welding.

### DETAILED DESCRIPTION OF EXEMPLARY EMBODIMENTS

For those skilled in the art to understand the characteristics, contents, advantages, and effects of the present invention, detailed description will be made with reference to drawings appended and through presentation of embodiments. Drawings referred in the present invention are to illustrate and support the application, not necessarily drawn to actual scale or serve as precise arrangement while performing the present invention; thus, it should be appreciated the scale and arrangement of the drawings appended are not to limit the claims when carrying out the present invention.

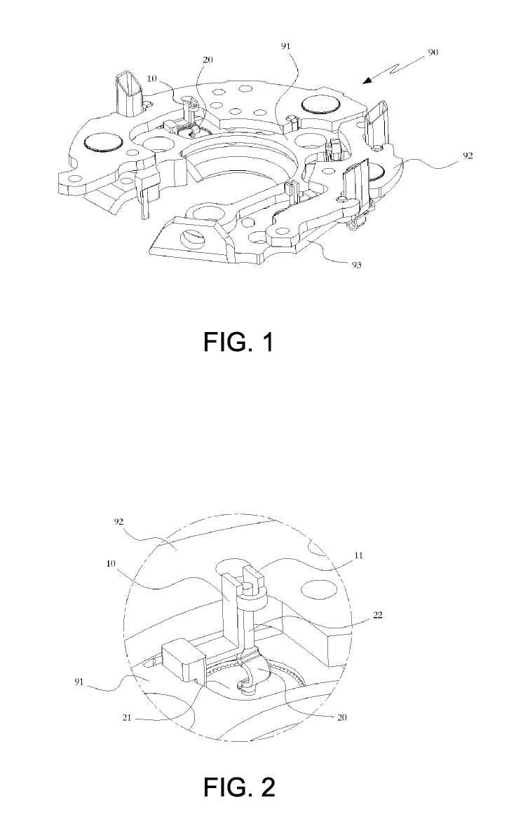

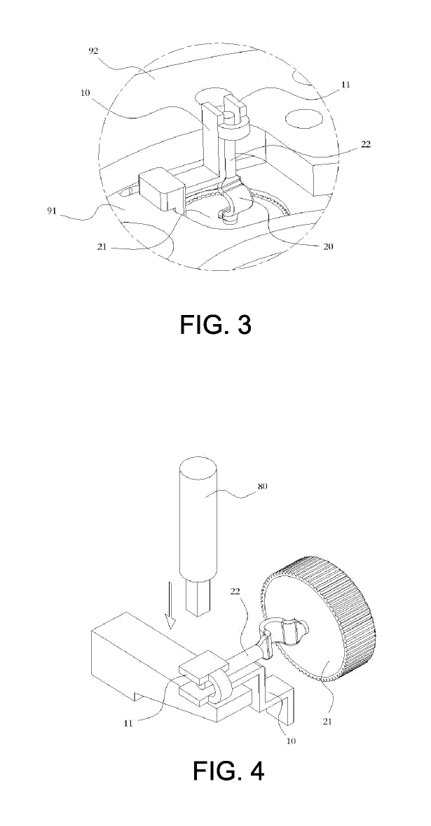

With reference to FIG. 1 to FIG. 3, a welding assembled structure of a diode in a rectifier for a generator according to one preferred embodiment of the present invention may include a solid joint lead 10 and a diode 20.

The aforementioned solid joint lead 10 is fixed on a leader frame 91 of the rectifier 90, and is a lengthwise member made of a metal-based conductive material (e.g. copper). The solid joint lead 10 has one end contacting a fringe of the leader frame 91, and an opposite extended end bent and extended outward the leader frame 91. The solid joint lead 10 further has a soldering tag 11 located at one side of the extended end. The soldering tag 11 has a width narrowed at a connecting portion to which the solid joint lead 10 is connected so that a U-shaped restricting area is defined between the soldering tag 11 and the solid joint lead 10 before the soldering tag 11 is later welded.

The foregoing diode 20 may further include a fixed mount 21 and a pin 22. The fixed mount 21 is a columnar member with a toothed periphery and is penetratingly fixed inside one of a positive slice 93 and a negative slice 92 of the rectifier 90. The positive and negative slices 93, 92 are fixed in parallel with respect to each other on the leader frame 91. The pin 22 is coupled with the fixed mount 21 and extends towards the leader frame 91, with an extended end thereof corresponding to the restricting area defined by the solid joint lead 10 and its soldering tag 11.

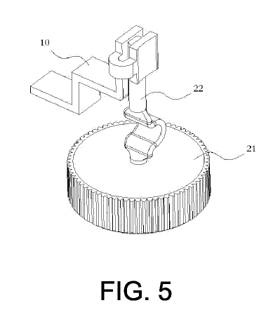

Further, with reference to FIG. 4, the soldering tag 11 of the solid joint lead 10 is then welded by a spot welding tip 80 of a spot welder, or any other spot welding device at a high temperature. Afterward, a pressure is applied to the soldering tag 11 to cause its deformation while the soldering tag 11 is melted under heat, so as to bend and affix the pin 22 of the diode 20 to the solid joint lead 10 (with reference to FIG. 5). As a result, the solid joint lead 10 and its soldering tag 11 can clamp and fix the pin 22 of the diode 20 after cooled, so as to achieve the effect of firm conjunction.

The advantage of the present invention is that the diode 20 is secured between the solid joint lead 10 and the soldering tag 11 by spot welding from loosening during operation, thereby ensuring the performance of the rectifier. In addition, the narrowed connecting portion of the soldering tag 11 leads to a relatively large resistance thereon when a current flow passes therethrough during spot welding, so as to produce instantaneous high heat that facilitates welding, thereby achieving convenient fabrication. By using spot welding, not only can the process be efficient and fast, but also the manufacture costs can be significantly reduced.

The embodiment discussed is to describe technological concept and characteristics of the present invention, further enabling those skilled in the art to understand and to perform based on contents of the present invention, not to limit the claims thereof. Therefore, any modifications or amendments made according to the spirit of the present invention should be encompassed in the claims thereof.

What is claimed is:

1. A welding assembled structure of a diode in a rectifier for a generator, comprising:
a solid joint lead which is a lengthwise member made of a metal-based conductive material and fixed on a leader frame of the rectifier, with one end contacting a fringe of the leader frame, and an opposite extended end bent and extended outward the leader frame while having a soldering tag located at one side of the extended end, wherein the soldering tag has a width narrowed at a connecting portion to which the solid joint lead is connected so that a U-shaped restricting area is defined between the soldering tag and the solid joint lead before the soldering tag is later welded; and
the diode comprising a fixed mount and a pin, wherein the fixed mount is a columnar member with a toothed periphery, and the pin is coupled with the fixed mount and extends towards the solid joint lead, an extended end of the pin corresponding to the restricting area defined by the solid joint lead and the soldering tag;
wherein the soldering tag is welded by a spot welding process and is pressed toward the solid joint lead when melted at a high temperature, so that the soldering tag deforms and clamps the pin of the diode together with the solid joint lead.

2. The welding assembled structure of claim 1, wherein the soldering tag has a width narrowed at a connecting portion to which the solid joint lead is connected.

3. The welding assembled structure of claim 1, wherein the solid joint lead is made of copper.
